(19) United States
(12) Patent Application Publication
(10) Pub. No.: US 2006/0145549 A1
(43) Pub. Date: Jul. 6, 2006

(54) Electric motor position sensing device and method

(76) Inventor: Darrell Frederick Greene, Huntsville, CA (US)

Correspondence Address: GIFFORD, KRASS, GROH, SPRINKLE & CITKOWSKI, P.C, PO BOX 7021, TROY, MI, 48007-7021, US

(21) Appl. No.: 11/028,903

(22) Filed: Jan. 4, 2005

(51) Int. Cl. H02K 23/66

(52) U.S. Cl. 310/68 B

(57) ABSTRACT

An electric motor includes a rotation shaft and an armature coupled to the rotation shaft. A commutator is coupled to the rotation shaft and is electrically connected to the armature. At least two power brushes are fixed relative to the commutator for electrically coupling the armature to a power source. A rotational ring independent of the commutator is also coupled to the rotation shaft. At least one sensor brush is fixed relative to the rotational ring for detecting a voltage. The rotational ring includes a plurality of segments. At least two of the plurality of segments are electrically connected to the commutator through a diode.

### BACKGROUND OF THE INVENTION

The present invention relates to electric motors, and more particularly to electric motors having a position sensing device.

DC, or direct current, motors are commonly known in the art and they are used to provide a driving force for performing various mechanical operations and for driving various components. For example, DC motors are commonly used for power adjusted seating mechanisms. In such seating systems, a DC motor is associated with a driving mechanism such as a lead screw or other drive component connected to a seat. The seat may be adjusted to various positions based on actuation by an occupant of a vehicle. Such seating systems may also include memory functions such that various occupants can preprogram a desired position of a seat. Typically in such systems, there is a need to adjust the seat from a current seating position to a preprogrammed seating position requiring accurate positioning data from the DC motor.

Typically, the DC motors include a positioning device to determine a speed or position of a motor. Known prior art devices include Hall Effect sensors, optical encoders, and other such sensor mechanisms. However, known prior art sensing devices have limitations on the accuracy and precision of their sensing rotational movement. For example, if the DC motor were to slow or stop and bounce back causing an unpredictable and intermittent output with a prior art sensor, false signals indicating additional rotations of a rotation shaft may be sensed by the sensor. Improvements to such sensing techniques can be made using multiple sensing devices, additional electronics, and/or digital processing but dramatically increasing cost. There is therefore a need in the art for a sensor for an electric motor that is immune to contact bounce, changes in rotational direction and wind-back from an electric motor. There is also a need for such a system that has a minimum number of components and is economical and easy to manufacture.

### SUMMARY OF THE INVENTION

An electric motor includes a rotation shaft and an armature coupled to the rotation shaft. A commutator is coupled to the rotation shaft and is electrically connected to the armature. At least two power brushes are fixed relative to the commutator for electrically coupling the armature to a power source. A rotational ring independent of the commutator is also coupled to the rotation shaft. At least one sensor brush is fixed relative to the rotational ring for detecting a voltage. The rotational ring includes a plurality of segments. At least two of the plurality of segments are electrically connected to the commutator through a diode.

There is also disclosed a method of detecting a position of an electric motor including the steps of: a) providing a commutator coupled to a rotation shaft; b) providing at least two power brushes fixed relative to the commutator; c) providing a rotational ring independent of the commutator and coupled to the rotation shaft, the rotational ring including a plurality of segments with at least two of the plurality of segments electrically connected to the commutator through a diode; d) providing at least one sensor brush fixed relative to the rotational ring; e) providing a circuit for logic switching; f) detecting a voltage at the sensor brush for a first position of the rotational ring; g) switching the logic circuit to a logic high condition in the response to the detected voltage; h) locking the logic high condition in the logic circuit; i) detecting a voltage at the sensor brush for a second position of the rotational ring; j) unlocking and switching the logic circuit to a logic low condition in response to the detected voltage; k) locking the logic low condition in the logic circuit; l) repeating steps f)-k) as the rotation shaft turns; and m) determining the number of revolutions a motor has completed corresponding to the number of transitions between logic high and logic low conditions, and/or the position of the mechanism being driven.

### BRIEF DESCRIPTION OF THE DRAWINGS

FIG. 1 is a schematic representation of a ten-pole DC motor in a first position according to a first embodiment of the present invention;

FIG. 2 is a schematic representation of the motor of FIG. 1 in a second position;

FIG. 3 is a partial front and end view of a DC motor including the commutator and rotational ring according to a first embodiment of the present invention;

FIG. 4 is a schematic representation of a ten-pole DC motor in a first position according to a second embodiment of the present invention;

FIG. 5 is a schematic representation of a ten-pole DC motor in a second position according to a second embodiment of the present invention;

FIG. 6 is a partial front and end view of the twelve-pole DC motor detailing the commutator and rotational ring according to the second embodiment of the present invention;

FIG. 7 is a schematic representation of a first embodiment of a signal conditioning circuit for use by the present invention;

FIG. 8 is a schematic representation of a second embodiment of a signal conditioning circuit for use by the present invention;

FIG. 9 is a schematic representation of a third embodiment of a conditioning circuit for use by the present invention;

FIG. 10 is a partial front and end view of a ten-pole DC motor according to a first embodiment of the present invention; and

FIG. 11 is a partial front and end view of a ten-pole DC motor having a full diode bridge according to a second embodiment of the present invention.

FIG. 12 is a schematic representation of a ten-pole DC motor in a first position according to a second embodiment of the present invention where the rotational ring is offset relative to the commutator.

### DETAILED DESCRIPTION OF THE PREFERRED EMBODIMENTS

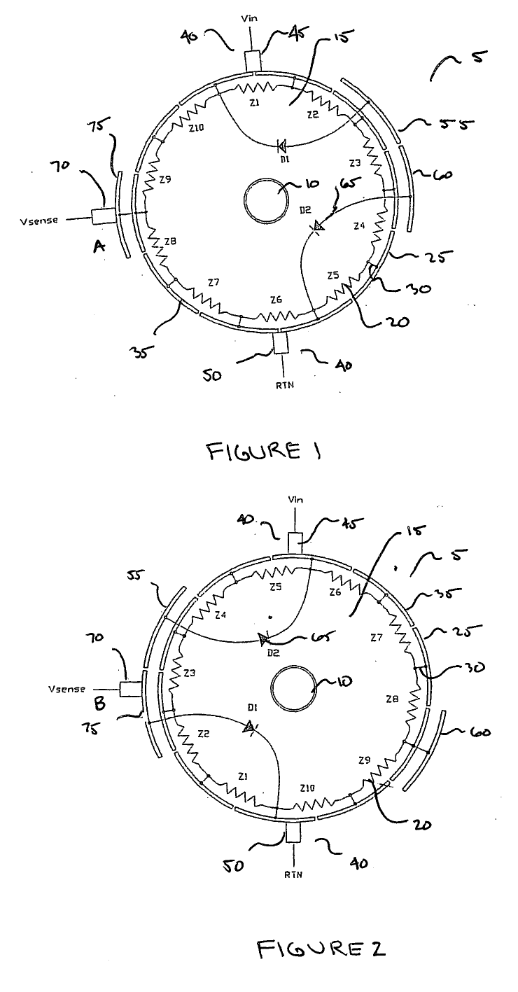

Referring to FIG. 1, there is shown a schematic representation of an electric motor 5 of a first embodiment of the present invention. A rotation shaft 10 is disposed centrally and surrounded by an armature 15 that is coupled to the rotation shaft 10. The armature 15 includes windings 20 numbered Z1-Z10. A commutator 25 is coupled to the rotation shaft 10 and is electrically connected to the armature 15 via connections 30. The commutator 25 shown in FIG. 1 includes ten segments 35. It should be realized that a commutator having any number of segments may be utilized by the present invention. In a preferred aspect of the invention, a commutator 25 having a number of segments 35 divisible by four is used. Such an arrangement allows for switching symmetry in either direction of rotation of the commutator 25.

At least two power brushes 40 are fixed relative to the commutator 25 for electrically coupling the armature 15 to a power source. The power brushes preferably include a voltage source 45 and a ground 50. A rotational ring 55 independent of the commutator 25 is coupled to the rotation shaft 10. The rotational ring 55 includes a plurality of segments 60, best seen in FIG. 5, as only a portion of the rotational ring is shown in the schematic representation of FIG. 1. At least two of the plurality of the segments 60 of the rotational ring 55 are electrically connected to the commutator 25 through a diode 65. At least one sensor brush 70 is fixed relative to the rotational ring 55 for detecting a voltage.

Again referring to FIG. 1, the impedances Z1-Z10 represent the armature windings 20 wherein Z represents equivalent resistive, inductive and capacitive properties of the armature windings. As can be seen in FIG. 1, a multilevel voltage divider circuit is formed by the windings 20 of the motor 5 such that at any node or junction 75 of consecutive windings a potential can be found that is lower than the voltage introduced at the power brush 45 or greater than the return 50 potential. As the power brushes make contact with various of the commutator segments 35, a series circuit shown in FIG. 1 including Z10-Z7 is formed. Each of the impedances Z1-Z10 are equivalent such that the voltage potential at the node of Z8 and Z9 in contact with the sensor brush can be represented by the following equation:
Vsense=(Vin×(Z8+Z7))/(Z7+Z8+Z9+Z10))=½Vin.

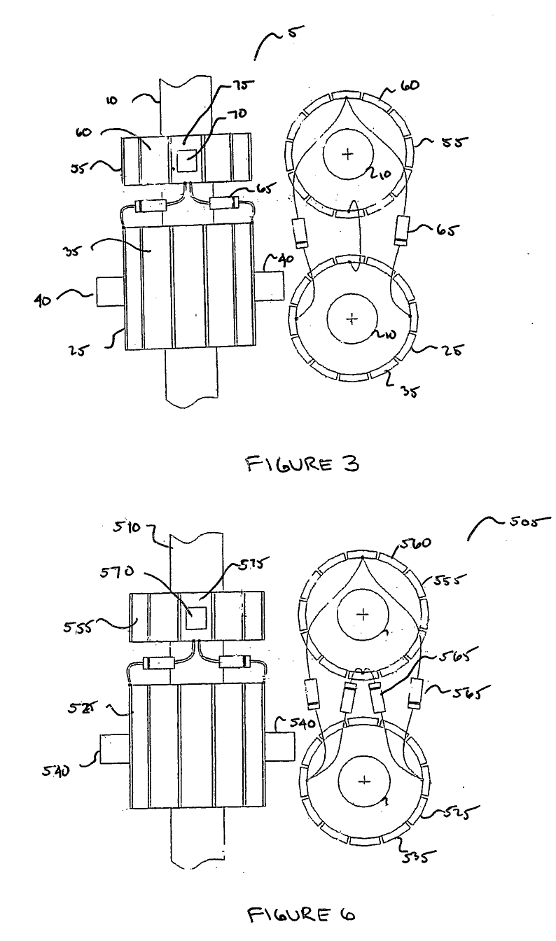

The voltage sensed by the sensor 70 is transmitted via use of the rotational ring 55 that includes at least one sensor ring segment 75 in contact with the sensor brush 70. The sensor ring segment 75, as defined and used in this application, is that portion of the rotational ring 55 that is currently in contact with the sensor brush 70 fixed relative to the rotational ring 55. As can be seen in FIG. 1, there is shown a first position A where the at least one sensor ring segment 75 is directly electrically connected to the commutator 25. At this point, the voltage sensed by the sensor brush 70 equals ½ Vin. It can be seen that this level of voltage is sensed independent of the rotational direction of the rotation shaft 10. The voltage sensed by the sensor brush 70 is provided to a conditioning circuit 80 for determining a position of the electric motor 5, as will be discussed in more detail below. Referring to FIG. 2, as the rotation shaft 10 continues to rotate clockwise, the sensor brush 70 makes contact with the sensor ring segment 75 of the rotational ring 55 coupled to a diode 65. The diode 65 is connected to the commutator 25 such as to provide a discharge path to ground or return potential 50 supply of the motor 5. In this second position B, the conditioning circuit 80 associated with the sensor brush 70 toggles between a separate setting from that of the first position, as will be discussed in more detail below.

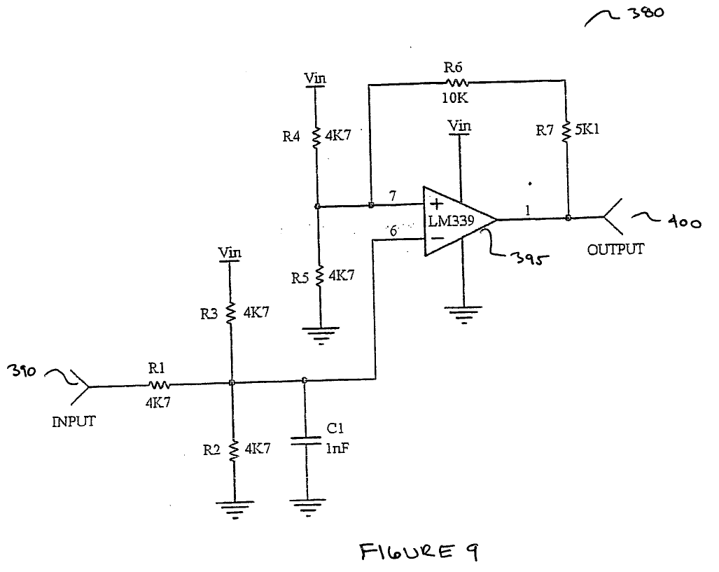

Referring to FIG. 7, there is shown a first embodiment of a conditioning circuit 80 for use by the motor 5 of the present invention. As the motor armature 15 rotates from the first position A to the second position B, the sensor brush 70 comes into contact with a segment 60 of the rotational ring 55 that is directly connected to a segment 35 of the commutator 25 corresponding to the first position shown in FIG. 1. This transfers a small amount of current to the input 90 of the conditioning circuit 80 and attempts to charge the capacitor C1 to approximately ½ Vin. The charging of the capacitor is limited by a diode 82 in the conditioning circuit 80 connected to a 5-volt source 84. If the signal in the conditioning circuit 80 is above a threshold amount of the AND gate device 95, approximately 3.5 volts in the pictured embodiment, the output 100 of the conditioning circuit 80 will go logic HIGH. Components R3 and C2 act as an R-C filter to limit switching rise and fall times. The HIGH output is fed back to the input 90 of the conditioning circuit 80 via R2. Therefore, as the armature 15 continues to spin and the sensor brush 70 contacts an area of the rotational ring 55 that has no electrical connection, the output 100 of the conditioning circuit 80 is locked as a logic HIGH. If the armature 15 were to slow or stop or intermittently bounce back making contact with the sensor brush 70, the output 100 of the conditioning circuit 80 would be unaffected and remain locked HIGH. In this manner, false signals indicating rotation of the shaft 10 are avoided.

As the armature 15 continues to rotate, the sensor brush 70 comes into contact with the segment 60 of the rotational ring 55 that is connected to a diode 65, D1, as shown in FIG. 2 and previously discussed above. This contact in the second position B causes the capacitor C1 to lose charge through R1 via the diode 65 in contact with the sensor brush 70 and the low side power brush or ground 50. When the level of C1 drops below the threshold voltage of the AND gate device 95, approximately 2.5 volts in the pictured embodiment, the output 100 of the device will go logic LOW. The LOW output is fed back to the input 90 via R2. Therefore, as the armature 15 continues to spin and the sensor brush 70 contacts an area that has no electrical connection, the output 100 of the conditioning circuit 80 is locked as logic LOW. Again, if the armature 15 were to slow down or bounce back making an intermittent contact with the sensor brush 70, the output 100 of the conditioning circuit 80 is unaffected and remains locked LOW.

One revolution of the armature 15 or shaft 10 is indicated by a full charge and discharge cycle defined by the conditioning circuit 80 as a HIGH to LOW back to HIGH cycle. As stated above, the HIGH or LOW condition is locked in the conditioning circuit 80 until it is reset or cleared by rotating half a turn of the armature 15 from the first position A to the second position B and then from the second position B back to the first position A, as the armature 15 rotates. In this manner, back winding or changes in rotational direction do not affect the sensor signal of the conditioning circuit 80 and therefore do not affect a calculation of a position of an electric motor.

Referring to FIG. 8, there is shown a second embodiment of a conditioning circuit 280 for use by the electric motor 5 of the present invention. Again, the function of the conditioning circuit 280 is similar to that of the first embodiment of the conditioning circuit 80 shown in FIG. 7. However, the AND gate device 95 has been replaced by discrete components 297, including a Zener diode 299 that is utilized to set the reference voltage for the switching function. The toggling of logic transitions from a HIGH to LOW state is again based on a position of the sensor ring 75 of the rotational ring 55 moving from a first position A to a second position B, as described above.

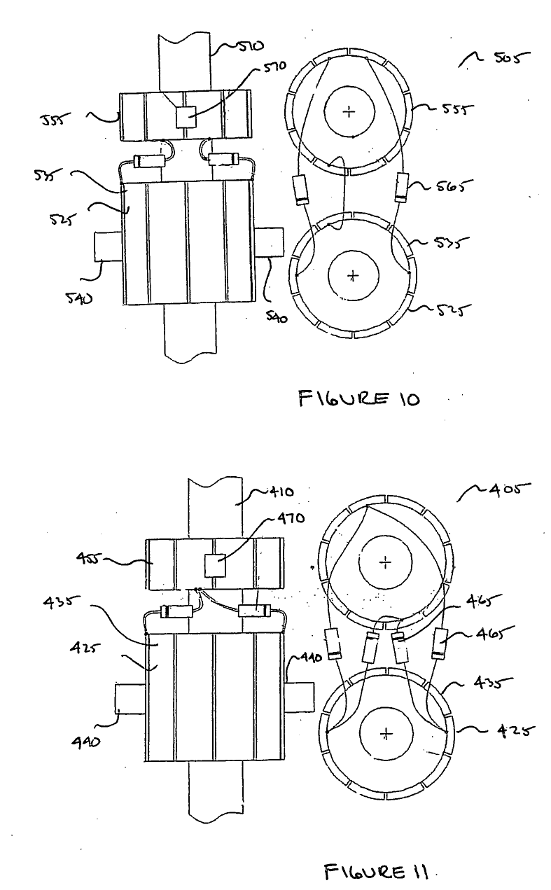

Referring to FIG. 9, there is shown a third embodiment of a conditioning circuit 380 for use by the electric motor of the present invention. As can be seen from the figure, the conditioning circuit utilizes a comparator 395 to condition the signal. A reference voltage of ½ Vin is set up by the voltage divider R4 and R5 on the positive input. On the negative input, another voltage reference is set by R2 and R3. Positive feedback via R6 locks the output between the HIGH and LOW conditions, as previously described above.

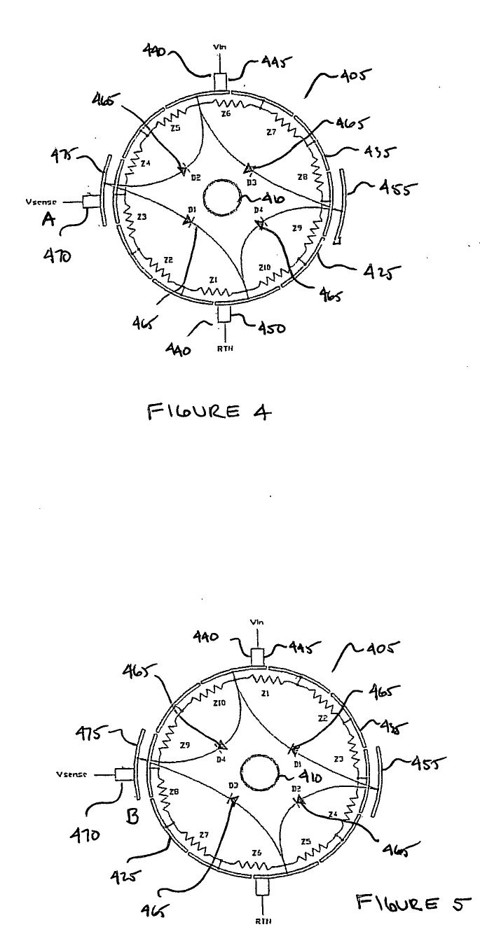

Referring to FIGS. 4, 5, and 12 there is shown a second embodiment of an electric motor 405 according to the present invention. The second embodiment is similar to that of the first with the exception that the rotational ring 455 is connected to the commutator 425 utilizing a diode bridge 465. As with the previously described first embodiment, the rotational ring 455 includes a sensor ring segment 475 in contact with the sensor brush 470 that changes as the shaft 410 rotates. As shown in FIG. 4, in the first position A, the sensor ring segment 475 is connected to the return or ground via D1 for one polarity applied to the motor power brushes 440 or to the return or ground via D2 for opposite polarity. As shown in FIG. 5, in the second position B, the sensor ring segment 475 is connected to the Vin or voltage in via D4 for one polarity applied to the motor power brushes 440 or to the Vin or voltage via D3 for opposite polarity.

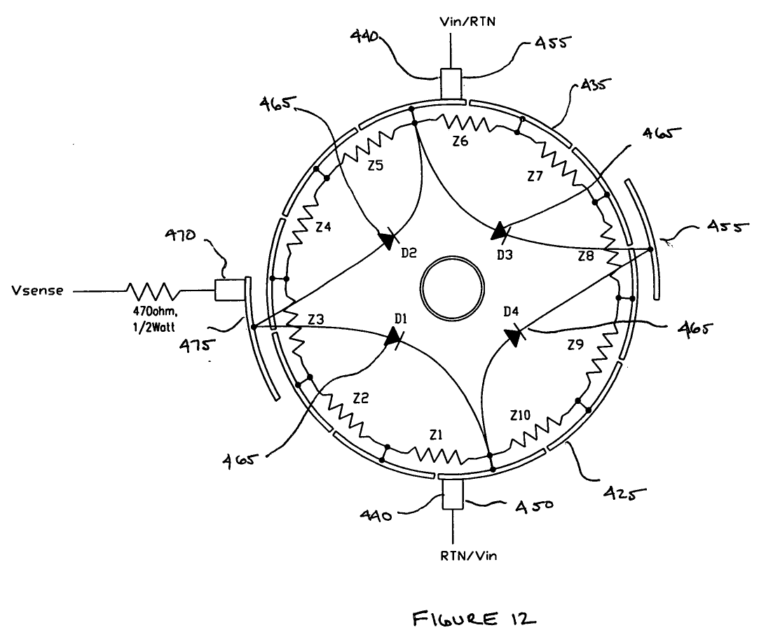

Referring to FIGS. 4, 5, 11 and 12, operation of the second embodiment of the electric motor 405 including four diodes 465 forming a voltage rectifying bridge will be described with reference to the conditioning circuit 380 of the third embodiment shown in FIG. 9. A reference voltage of ½ Vin is set up by the voltage divider R4 and R5 on the positive input of the comparator 395. On the negative input of the comparator 395, another voltage reference is set by R2 and R3. Positive feedback via R6 allows the output from the conditioning circuit 380 to be locked HIGH or LOW depending on the sensor ring segment 60 in contact with the sensor brush 70. As the armature 415 rotates the divider network on the input is connected via R1 to segments on the rotational ring 455 that are connected by the diodes either D1 and D2 for the voltage in or D3 and D4 for the return or ground. R1 which is preferably located within the motor 405 provides a short circuit protection by limiting current. In this embodiment, one segment 460 of the rotational ring 455 provides a path to Vin, the other a path to return. The voltage divider of R2 and R3 therefore biases the diode and the voltage on the positive input to the comparator 395 above ½ Vin on one segment and below ½ Vin on the other. Hysteresis is provided by R6 such that a set/reset function is performed. Thus, one revolution of the rotation shaft 410 is required for a full HIGH to LOW to HIGH cycle in the conditioning circuit 380. Therefore, any reverse or back winding of an armature 415 on either the positive or negative polarity of the rotational ring 455 does not have an adverse effect on the number of HIGH or LOW conditions in the circuit 380 thereby providing an accurate determination of the position of an electric motor 405.

In FIG. 12, there is shown a preferred orientation of the second embodiment of the electric motor 405. In the pictured embodiment the rotational ring 455 is offset relative to the commutator 425. In this manner, when the sensor ring segment 475 contacts the sensor brush 470, the commutator segment 435 contacts the voltage in 455 simultaneously.

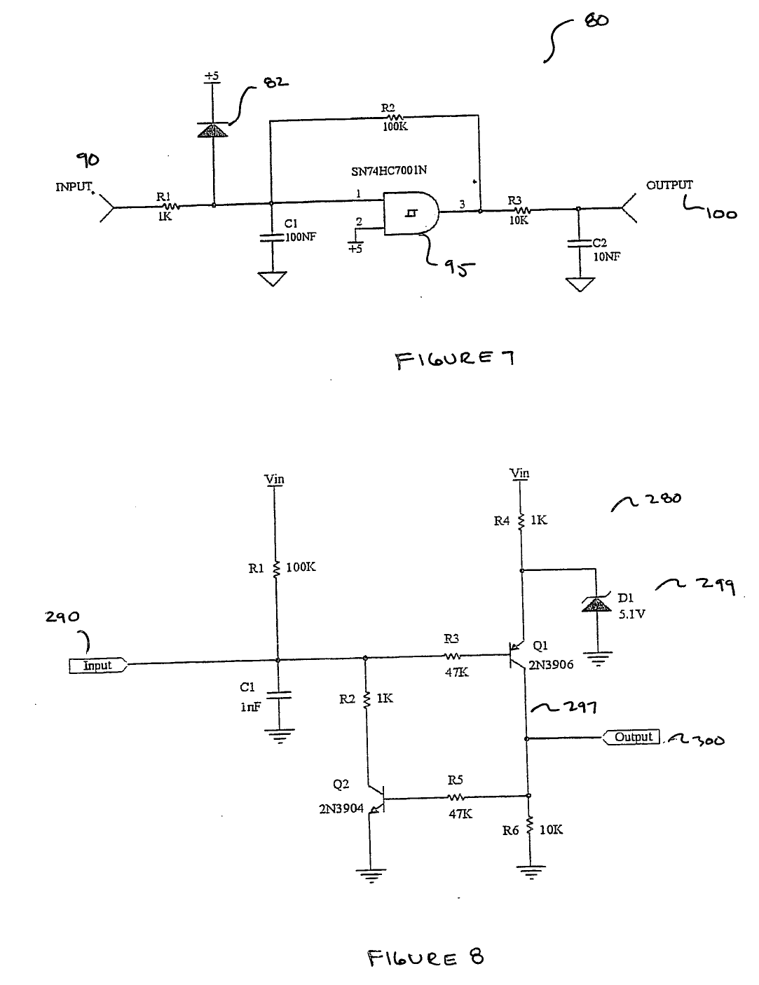

Referring to FIGS. 3 and 6, there are shown alternative embodiments of electric motors for use by the present invention. The pictured alternative embodiments show an electric motor 505 having a 12-pole or 12-segment 535 commutator 525 coupled to the rotation shaft 510. The operation of such alternative embodiments is similar to that as that described above with respect to the 10-pole or 10-segment 35 commutator 25 design. Any of the conditioning circuit designs including the first, second and third embodiments may be utilized by any of the embodiments of the electric motor. It should be realized that many embodiments of this invention may be utilized and are not limited by the number of poles or segments 35 of the commutator 25, number of diodes 65, or by position or connection of the diodes 65 to the rotational ring 55 and commutator 25.

There is also disclosed herein a method of detecting a position of an electric motor comprising the steps of: a) providing a commutator coupled to a rotation shaft; b) providing at least two power brushes fixed relative to the commutator; c) providing a rotational ring independent of the commutator and coupled to the rotation shaft, the rotational ring including a plurality of segments with at least two of the plurality of segments electrically connected to the commutator through a diode; d) providing at least one sensor brush fixed relative to the rotational ring; e) providing a circuit for logic switching; f) detecting a voltage at the sensor brush for a first position of the rotational ring; g) switching the logic circuit to a logic HIGH condition in response to the detected voltage; h) locking the logic HIGH condition in the logic circuit; i) detecting a voltage at the sensor brush for a second position of the rotational ring; j) unlocking and switching the logic circuit to a logic LOW condition in response to the detected voltage; k) locking the logic LOW condition in the logic circuit; l) repeating steps f)-k) as the rotation shaft turns; and m) determining a position of the electric motor corresponding to the number of transitions between logic HIGH and logic LOW conditions. It should be realized that the method outlined above may be utilized by any of the embodiments of the electric motor previously described above. Additional steps including filtering or conditioning the signal within the logic circuit may be performed by the method of the present invention.

The invention has been described in an illustrative manner. It is to be understood that the terminology which has been used is intended to be in the nature of words of description rather than limitation. Many modifications and variations of the invention are possible in light of the above teachings. Therefore, within the scope of the appended claims, the invention may be practiced other than as specifically described.

1. An electric motor comprising:
a rotation shaft and an armature coupled to the rotation shaft;
a commutator coupled to the rotation shaft and electrically connected to the armature;
at least two power brushes fixed relative to the commutator for electrically coupling the armature to a power source;
a rotational ring independent of the commutator and coupled to the rotation shaft;
at least one sensor brush fixed relative to the rotational ring for detecting a voltage;
the rotational ring including a plurality of segments, at least two of the plurality of segments electrically connected to the commutator through a diode.

2. The electric motor of claim 1 wherein the plurality of segments of the rotational ring includes at least one sensor ring segment in contact with the sensor brush.

3. The electric motor of claim 2 wherein the at least one sensor ring segment is directly electrically connected to the commutator in a first position.

4. The electric motor of claim 3 wherein the at least one sensor ring segment is electrically connected through the diode to the commutator in a second position.

5. The electric motor of claim 4 wherein the commutator in the second position is coupled to ground.

6. The electric motor of claim 2 wherein the sensor ring segment is connected to the commutator through a diode bridge in a first position.

7. The electric motor of claim 2 wherein the sensor ring segment is connected to the commutator through a diode bridge in a second position.

8. The electric motor of claim 6 wherein the commutator in the first position is coupled to the power source.

9. The electric motor of claim 7 wherein the commutator in the second position is coupled to ground.

10. The electric motor of claim 3 further including a conditioning circuit associated with the at least one sensor brush.

11. The electric motor of claim 10 wherein the conditioning circuit has an output that toggles between a high and low setting corresponding to rotation of the sensor ring segment between the first and second positions.

12. The electric motor of claim 11 wherein the high and low settings are locked until the sensor ring segment passes between the first and second positions for preventing false signals from the conditioning circuit.

13. The electric motor of claim 11 wherein a single rotation of the armature is indicated by a cycle defined by a high to low to high toggling of the setting of the conditioning circuit.

14. A method of detecting a position of an electric motor comprising the steps of:
a) providing a commutator coupled to a rotation shaft;
b) providing at least two power brushes fixed relative to the commutator;
c) providing a rotational ring independent of the commutator and coupled to the rotation shaft, the rotational ring including a plurality of segments, at least two of the plurality of segments electrically connected to the commutator through a diode;
d) providing at least one sensor brush fixed relative to the rotational ring;
e) providing a circuit for logic switching;
f) detecting a voltage at the sensor brush for a first position of the rotational ring;
g) switching the logic circuit to a logic high condition in response to the detected voltage;
h) locking the logic high condition in the logic circuit;
i) detecting a voltage at the sensor brush for a second position of the rotational ring;
j) unlocking and switching the logic circuit to a logic low condition in response to the detected voltage;
k) locking the logic low condition in the logic circuit;
l) repeating steps f)-k) as the rotation shaft turns; and
m) determining a position of the electric motor corresponding to the number of transitions between logic high and logic low conditions.

15. The method of detecting a position of an electric motor of claim 14 further including the step of filtering the logic circuit.

16. The method of detecting a position of an electric motor of claim 14 wherein the rotational ring is directly electrically connected to the commutator in the first position.

17. The method of detecting a position of an electric motor of claim 14 wherein the rotational ring is electrically connected through the diode to the commutator in the second position.

18. The method of detecting a position of an electric motor of claim 17 wherein the commutator in the second position is coupled to ground.

19. The method of detecting a position of an electric motor of claim 14 wherein the rotational ring is connected to the commutator through a diode bridge in the first position.

20. The method of detecting a position of an electric motor of claim 14 wherein the rotational ring is connected to the commutator through a diode bridge in the second position.
